(19) United States
(12) Patent Application Publication
(10) Pub. No.: US 2018/0259909 A1
(43) Pub. Date: Sep. 13, 2018

(54) SENSOR ATTACHMENT STRUCTURE AND WRISTWATCH

(71) Applicant: SEIKO EPSON CORPORATION, Tokyo (JP)

(72) Inventors: Atsushi KOBAYASHI, Shiojiri-shi (JP); Yoshio MISHIMA, Matsumoto-shi (JP)

(73) Assignee: SEIKO EPSON CORPORATION, Tokyo (JP)

(21) Appl. No.: 15/913,182

(22) Filed: Mar. 6, 2018

(30) Foreign Application Priority Data
Mar. 13, 2017 (JP) 2017-047036

(51) Int. Cl. G04B 47/06; G04B 37/08

(52) U.S. Cl. CPC G04B 47/066; B63C 11/02; G04B 37/08

(57) ABSTRACT

A sensor is accommodated in an accommodation portion provided in a housing. An attachment surface portion of the housing is provided on the outside surface of a case of an information device. A sensor cover is provided which fixes a sensor accommodated in the accommodation portion of the housing between the housing and the sensor cover. The housing accommodating the sensor can be attached to an attachment surface portion provided in the case together with the sensor cover.

### CROSS-REFERENCE TO RELATED APPLICATION

This application claims priority from Japanese patent application JP 2017-047036 filed Mar. 13, 2017, which is incorporated herein by reference in its entirety.

### BACKGROUND

### 1. Technical Field

The present invention relates to a sensor attachment structure for mounting a sensor on an information device and a wristwatch.

### 2. Related Art

A pressure sensor for measuring the depth at the time of diving, the altitude at the time of climbing, or the like is mounted on a portable device such as a wristwatch, as described in JP-A-2005-181327. An information device described in JP-A-2005-181327 has a structure attaching the pressure sensor by providing a sensor accommodation portion including an opening portion which completely penetrates an annular portion of a case thereof in the annular portion thereof and incorporating the pressure sensor and a cap which covers the outside thereof in the sensor accommodation portion. In addition, in the information device of the related art, the cap and a fixed frame provided inside the case are coupled to each other and the pressure sensor is fixed between the cap and the fixed frame.

In the information device of the related art described above, it is necessary to provide an opening portion for accommodating and fixing the cap covering the pressure sensor in the annular portion of the case. Further, in the information device of the related art, it is necessary to provide a fixed frame for attaching the pressure sensor also on the inside of the annular portion of the case. Therefore, it is necessary to secure a space for accommodating the sensor of the case. In addition, in order to secure the sensor accommodation portion, restrictions are imposed on the design of an inside portion of the case.

### SUMMARY

An advantage of some aspects of the invention is to provide a sensor attachment structure, an information device, and a wristwatch that can decrease a space required for mounting a sensor provided in a case.

An aspect of a sensor attachment structure according to the invention is a sensor attachment structure which attaches a pressure sensor to a case of a wristwatch, the structure includes: a housing that is attached to an outside surface of the case and has an accommodation portion which accommodates the pressure sensor; the pressure sensor that is accommodated in the accommodation portion; and a sensor cover that includes a communication portion causing outside air to communicate with the pressure sensor and closes the accommodation portion.

According to the aspect of the sensor attachment structure described above, since the housing that accommodates the sensor is attached to the outside surface of the case, a space required in the case for attaching the sensor is small.

In the aspect of the sensor attachment structure described above, it is preferable that a cover is provided between the sensor cover and the pressure sensor and the cover has a hole having an opening area smaller than an opening area of the communication portion.

According to the aspect with this configuration, since the foreign matter intrusion prevention cover has a hole having an area smaller than the opening area of the communication portion, it prevents dust from intruding into the sensor and prevents dust or the like from being directly in contact with the sensor through the communication portion of the sensor cover.

In the aspect of the sensor attachment structure described above, it is preferable that the communication portion is a groove provided on a surface of the sensor cover on a side of the accommodation portion.

According to the aspect with this configuration, since the communication portion provided in the sensor cover is formed as a groove provided on the inside surface which is the surface of the sensor cover on the case side, intrusion of dust into the sensor is unlikely to be generated.

In the aspect of the sensor attachment structure of the invention described above, it is preferable that a packing which seals a gap between the accommodation portion and the pressure sensor is provided.

According to the aspect with this configuration, since the packing seals the gap between the accommodation portion and the sensor, air and water tightness can be secured.

In the aspect of the sensor attachment structure of the invention described above, it is preferable that the packing has a annular protrusion portion corresponding to the position of the gap between the pressure sensor and the accommodation portion.

According to the aspect with this configuration, the packing in contact with the sensor from the outside is formed into a two-mountain structure having annular protrusion portions on the inner peripheral side and the outer peripheral side thereof. A first annular protrusion portion on the inner peripheral side of the packing is in contact with a surface (surface on opposite side of case) of the sensor in a direction of the cover portion of the sensor and on the other hand, a second annular protrusion portion on the outer peripheral side is in contact with a surface (surface on opposite side of case) of the housing in a direction of a portion of the cover. Therefore, leakage of a fluid such as air, water, or the like from between the inner peripheral surface of the accommodation portion for accommodating the sensor and the outer peripheral surface of the sensor in the housing is prevented and high air and water tightness is secured. In addition, since the first annular protrusion portion and the second annular protrusion portion exhibit independent stretchability, respectively and the first annular protrusion portion on the inner peripheral side is in contact with the outside surface of the sensor, a positioning function which regulates the position of the sensor in the inner and outer direction is exhibited.

In the aspect of the sensor attachment structure of the invention described above, it is preferable that the housing has a stepped recessed portion which is provided continuously on the accommodation portion and into which the packing is fitted.

According to the aspect with this configuration, by forming the stepped recessed portion which accommodates the packing in the housing, the sensor and the packing can be easily assembled into the housing.

An aspect of a wristwatch according to the invention is a wristwatch in which an atmospheric pressure sensor is mounted from the outside of a case, including, at 4 o'clock position: a sensor attachment structure including a housing which is attached to an outside surface of the case and has an accommodation portion that accommodates the atmospheric pressure sensor, the pressure sensor which is accommodated in the accommodation portion, and a sensor cover which includes a communication portion causing the outside air to communicate with the pressure sensor and closes the accommodation portion.

According to the aspect, it is possible to prevent the wristwatch from becoming larger. In addition, if the sensor is provided at the 4 o'clock position of the wristwatch, a sensor which does not need to be operated is provided at a position where operation at the wristwatch is not easy, and operation elements can be provided at a suitable position such as 2 o'clock, 8 o'clock, 10 o'clock position. In addition, the pressure sensor is unlikely to be hit the surface of the wrist.

### BRIEF DESCRIPTION OF THE DRAWINGS

The invention will be described with reference to the accompanying drawings, wherein like numbers reference like elements.

FIG. 1 is a plan view illustrating a main portion of a wristwatch equipped with a sensor attachment structure which is one embodiment of an information device according to the invention.

FIG. 2 is an exploded perspective view illustrating the sensor attachment structure of this embodiment.

FIG. 3 is a view illustrating a state after assembly in the sensor attachment structure of this embodiment as viewed in a direction of an arrow E in FIG. 2.

FIG. 4A is an enlarged perspective view of the housing of FIG. 2, FIG. 4B is a perspective view illustrating the housing of this embodiment as viewed from a case side, and FIG. 4C is a view illustrating the housing of this embodiment as viewed in the direction of the arrow E in FIG. 2.

FIG. 5A is a view illustrating a packing provided between the housing and the foreign matter intrusion prevention cover of this embodiment as viewed from the case side, and FIG. 5B is a sectional view taken along line F-F in FIG. 5A.

FIG. 6 is a sectional view illustrating a cross section of the sensor attachment structure of this embodiment.

FIG. 7 is a view illustrating the sensor cover of this embodiment as viewed from the opposite side of the case.

FIG. 8 is a view illustrating a foreign matter intrusion prevention cover according to this embodiment as viewed from the opposite side of the case.

FIG. 9 is a perspective view illustrating another example of the sensor cover used for a wristwatch of this embodiment as viewed from the case side.

### DESCRIPTION OF EXEMPLARY EMBODIMENTS

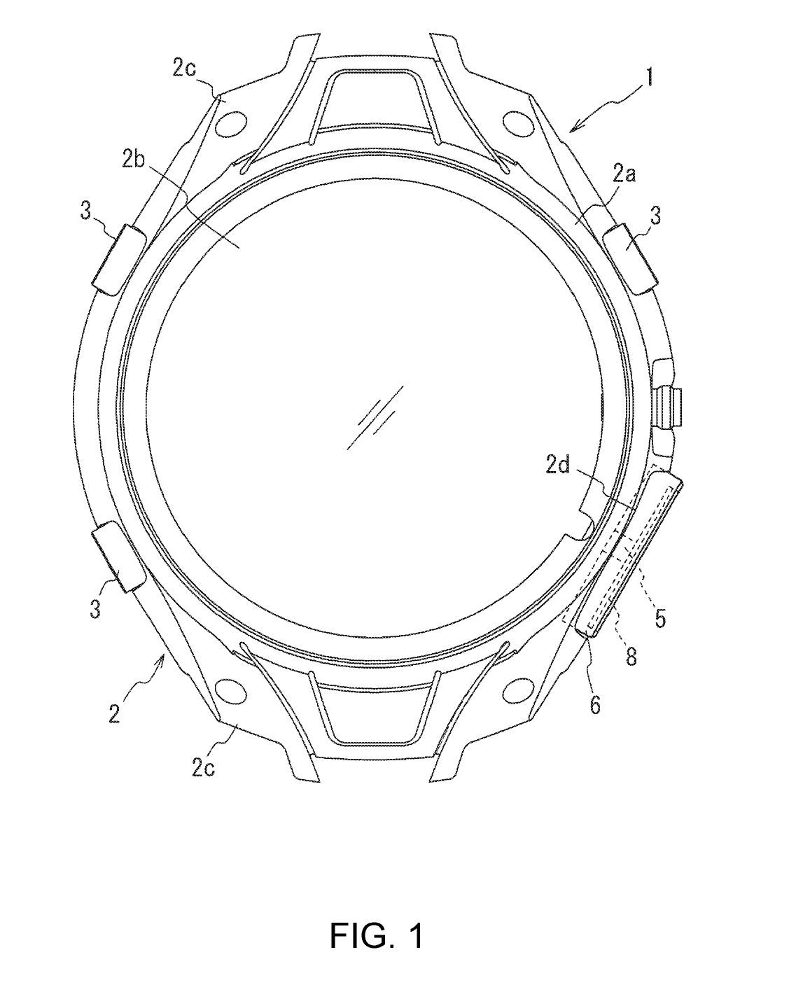

FIG. 1 to FIG. 4C are views illustrating one embodiment of a sensor attachment structure according to the invention and a wristwatch that is configured using the sensor attachment structure. In FIG. 1 to FIG. 4C, a wristwatch 1 omits illustration of a band for attaching to a wrist. The wristwatch 1 has a function of measuring atmospheric pressure and water pressure. Examples of such functions include an altitude estimation function based on the measured atmospheric pressure, a weather forecast function, a water depth estimation function, and a diving information display function.

A case 2 of the wristwatch 1 has an annular portion 2a and a transparent cover glass 2b provided on a surface portion of the case 2. A back cover (not illustrated) is attached to a back surface of the case 2. Band attachment portions 2c and 2c for connecting bands (not illustrated) are provided at both ends of the annular portion 2a. An electronic circuit (not illustrated) and a power supply (not illustrated) for displaying the time and the measurement value obtained from the detection signal by the sensor are accommodated in the case 2. Operation elements 3 for operating by a user are attached to the case 2.

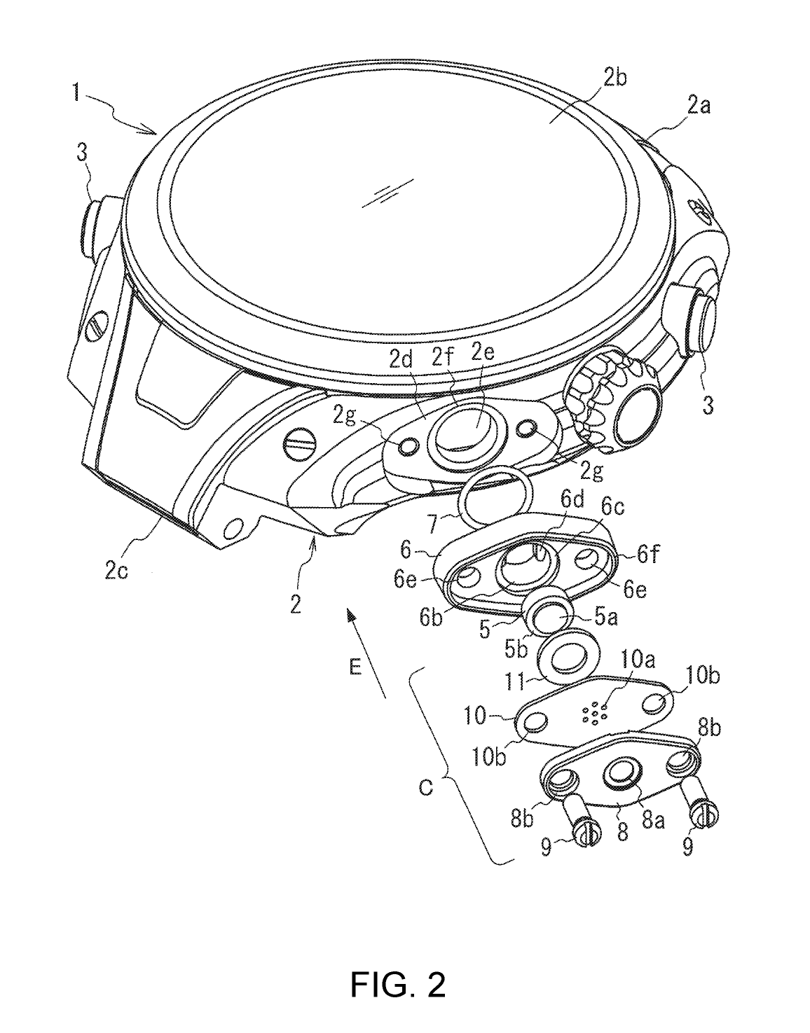

In FIG. 2, the sensor attachment structure for attaching a pressure sensor 5 to be attached to the wristwatch 1 includes a sensor attachment surface portion 2d that is provided on an outside surface of the annular portion 2a of the case 2, a housing 6 in which the pressure sensor 5 is accommodated, a packing 7 for a waterproof sealing that is provided between the housing 6 and the sensor attachment surface portion 2d, and a cover portion C. The cover portion C fixes the pressure sensor 5 between the cover portion C and the housing 6. Specifically, the cover portion C includes a sensor cover 8 and an attachment screw 9, a foreign matter intrusion prevention cover 10, and a packing 11 for a waterproof sealing. The sensor cover 8 covers the pressure sensor 5 and fixes the pressure sensor 5 between the sensor cover and the housing 6. The foreign matter intrusion prevention cover 10 is provided between the housing 6 and the sensor cover 8. The packing 11 is provided between the housing 6 and the foreign matter intrusion prevention cover 10.

As illustrated in FIG. 2, the sensor attachment surface portion 2d is formed on the outside surface of the case 2 as a recessed portion into which a portion of the housing 6 is fitted. A through-hole 2e for passing through a connection line (not illustrated) such as a connection wire or a contact for connecting the pressure sensor 5 and an electronic circuit accommodated inside the case 2 is provided at the center of the sensor attachment surface portion 2d. A stepped recessed portion 2f for fitting a portion of the packing 7 for waterproof sealing is formed on the outside of the through-hole 2e in the radial direction of the case 2. In addition, screw holes 2g for screwing the attachment screw 9 which attaches the sensor cover 8 to the housing 6 are provided on both sides of the through-hole 2e in the sensor attachment surface portion 2d.

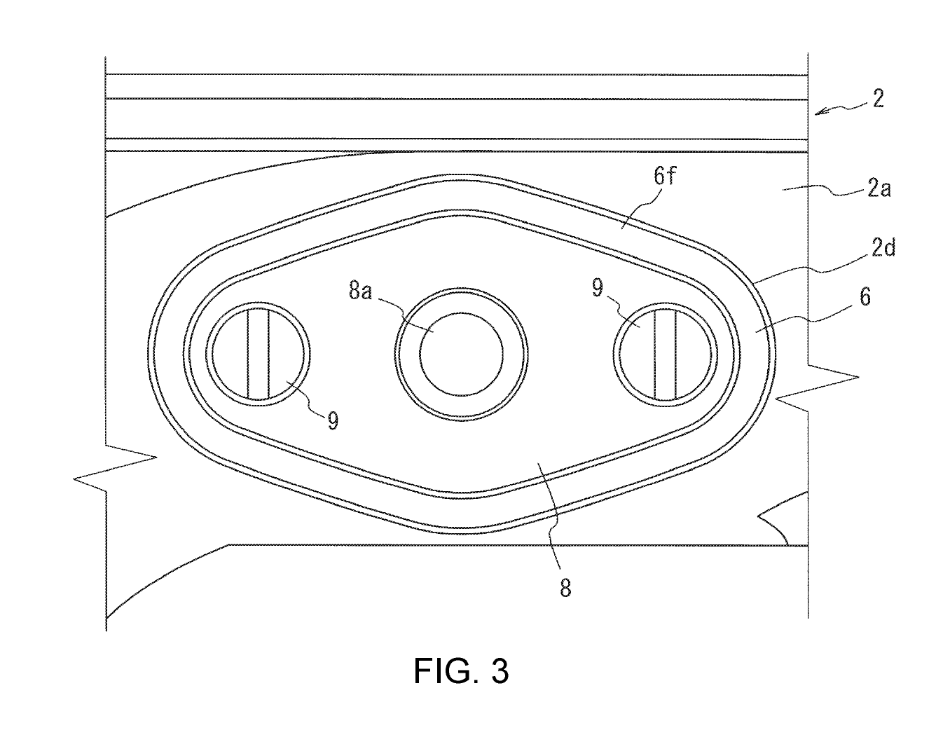

As illustrated in FIG. 3, when viewing the state after assembly in the sensor attachment structure as viewed from a direction of the arrow E in FIG. 2, the sensor cover 8 is pressed against the housing 6 by the attachment screw 9 to attach to the annular portion 2a of the case 2.

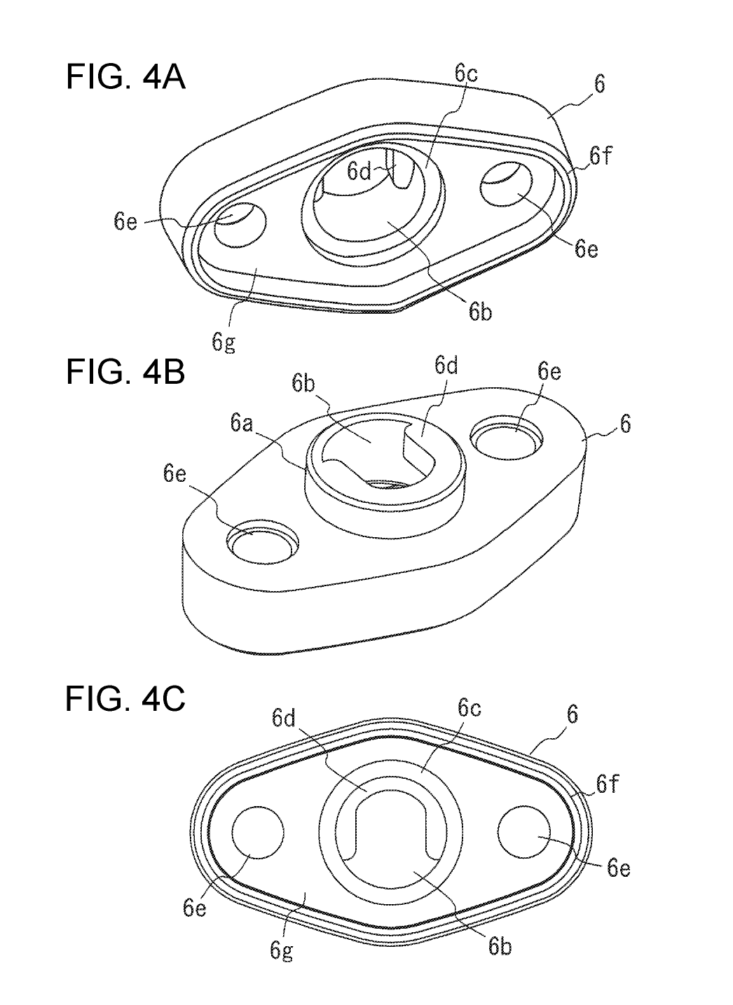

As illustrated in FIG. 4B, the housing 6 has a protrusion portion 6a protruding inward, which is the case 2 side. This protrusion portion 6a is fitted into the through-hole 2e of the sensor attachment surface portion 2d illustrated in FIG. 2. As illustrated in FIGS. 4A and 4C, the housing 6 has a circular accommodation portion 6b accommodating the pressure sensor 5 toward a radial direction of the case 2 in a region including the protrusion portion 6a. In addition, a stepped recessed portion 6c for fitting the packing 11 for waterproof sealing is formed so as to be continuous with the accommodation portion 6b on the surface of the housing 6 in a direction of the cover portion C.

In addition, a sensor support portion 6d for supporting the pressure sensor 5 from the case side is formed on the protrusion portion 6a of the housing 6 so as to protrude inward the circular accommodation portion 6b in the radial direction. The housing 6 has through-holes 6e provided on both sides of the accommodation portion 6b, and the through-holes 6e are for inserting the attachment screw 9. The housing 6 has a protrusion edge 6f formed so as to protrude outward from a surface 6g in contact with the sensor cover. The sensor cover 8 and the foreign matter intrusion prevention cover 10 are fitted in the region surrounded by the protrusion edge 6f and positioned.

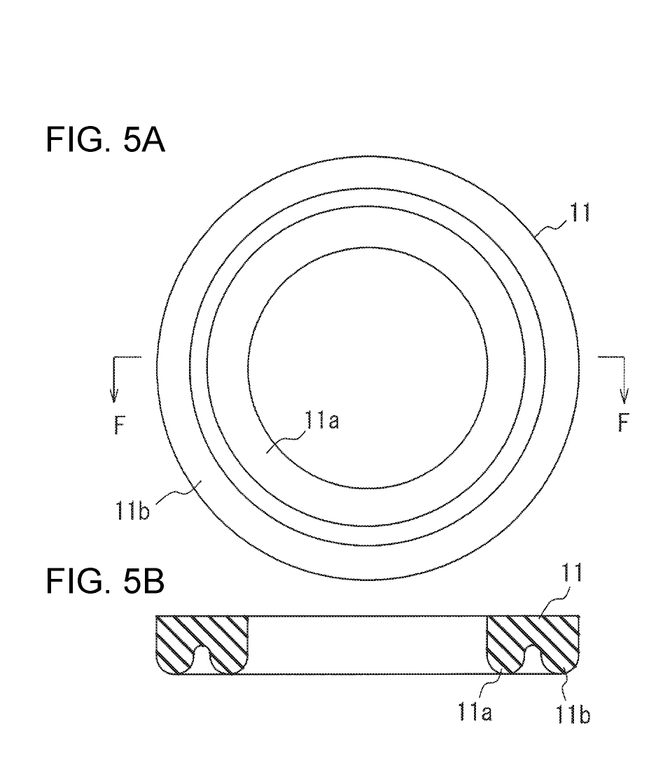

The material of the packings 7 and 11 is, for example, a fluorine-based rubber or the like and has elasticity. FIG. 5A is a plan view illustrating the packing 11, and FIG. 5B is a sectional view of the packing 11 taken along the broken line F-F in FIG. 5A. The packing 11 has a circular annular shape and has a concentric shape in which center of a first inner annular protrusion portion 11a and center of a second outer annular protrusion portion 11b substantially coincide with each other.

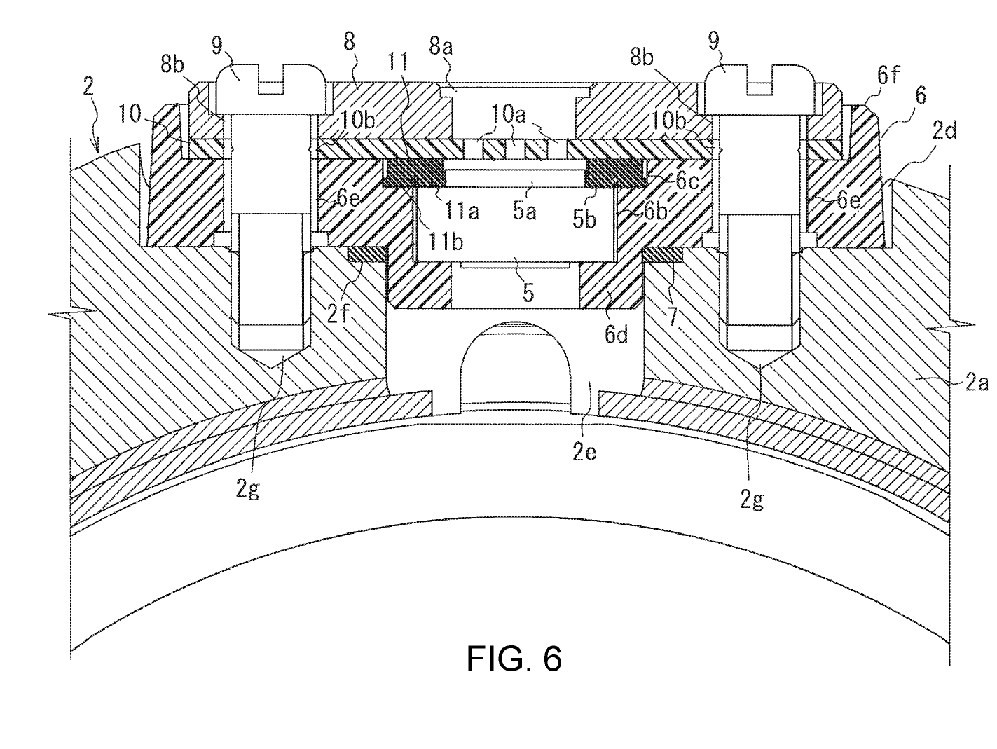

FIG. 6 illustrates a cross section of the sensor attachment structure of this embodiment. As illustrated in the FIG. 6, an outside surface portion 5b is provided around the protrusion portion 5a on the opposite side of the case 2 in the pressure sensor 5. The outside surface portion 5b is a surface of the pressure sensor 5 in a direction of the cover portion C accommodated in the accommodation portion 6b. In the outside surface portion 5b, the first annular protrusion portion 11a of the packing 11 is in contact with the outside surface portion 5b. On the other hand, the first annular protrusion portion 11a of the packing 11 is fitted into the stepped recessed portion 6c of the housing 6. In other words, the packing 11 has two mountain structure, an outside mountain is pressed against the housing 6 and an inside mountain is pressed against the pressure sensor 5. In this way, since each mountain is in contact with each of the two structures while being deformed, it is possible to reliably seal the gap between the housing 6 and the pressure sensor 5.

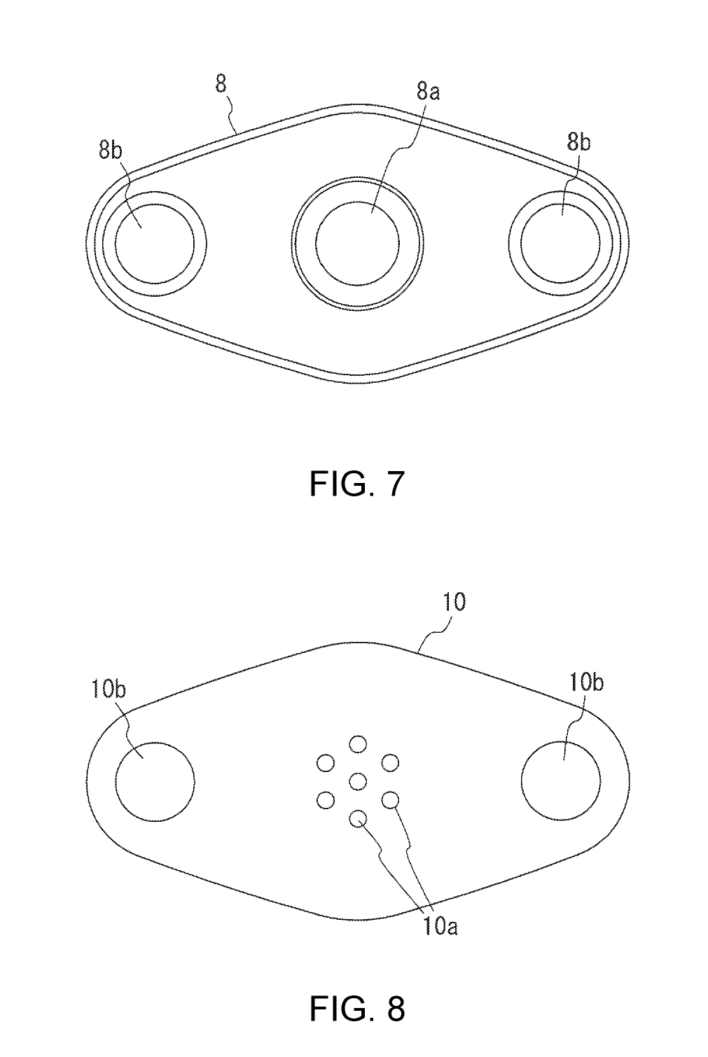

As illustrated in FIG. 7, the sensor cover 8 includes a communication portion 8a including a through-hole which communicates the outside with the pressure sensor via the sensor cover 8 in the central portion thereof in order to transmit pressure to a pressure detection portion (not illustrated) which is included in the pressure sensor 5. In addition, the sensor cover 8 is provided with through-holes 8b through which the attachment screws 9 are inserted at both sides of the communication portion 8a. As illustrated in FIG. 8, the foreign matter intrusion prevention cover 10 includes a plurality of small holes 10a in a central region facing the communication portion 8a of the sensor cover 8 which communicates the outside with air or water, while preventing the passage of small foreign matters such as dust. The small hole 10a is a circular hole having an area smaller than the opening area of the communication portion 8a. Through-holes 10b, 10b through which the attachment screw 9 is passed are provided on both sides of a region provided with a plurality of small holes 10a in the foreign matter intrusion prevention cover 10. A Teflon (registered trademark) sheet that allows air to pass therethrough but does not allow foreign matter to pass therethrough may be interposed between the sensor cover 8 of FIG. 7 and the foreign matter intrusion prevention cover 10 of FIG. 8.

The pressure sensor 5 of this embodiment is attached to the case 2 with the structure illustrated in FIG. 6. In other words, the packing 7 is fitted into the stepped recessed portion 2f around the through-hole 2e of the attachment surface portion 2d provided in the annular portion 2a of the case 2, and the protrusion portion 6a provided on the housing 6 is fitted into the through-hole 2e of the attachment surface portion 2d, and a portion of the housing 6 is fitted into the attachment surface portion 2d. In addition, the pressure sensor 5 is fitted into the accommodation portion 6b of the pressure sensor 5 provided in the housing 6 and the packing 11 is fitted between the protrusion portion 5a provided outside the pressure sensor 5 and the stepped recessed portion 6c of the housing 6. In addition, the foreign matter intrusion prevention cover 10 and the sensor cover 8 are overlapped the packing 11 and are overlapped a protrusion edge 6f on the outer periphery of the housing 6 and fitted thereinto.

The attachment screw 9 is inserted through the through-hole 8b of the sensor cover 8, the through-hole 10b of the foreign matter intrusion prevention cover 10, and the through-hole 6e of the housing 6, and is threadedly engaged with the screw hole 2g provided to the attachment surface portion 2d of the case 2. Accordingly, the pressure sensor 5 is attached to the case 2 together with the housing 6, the packing 11, the foreign matter intrusion prevention cover 10 and the sensor cover 8. In addition, the packings 7 and 11 are compressed by fastening the housing 6 or the like with the attachment screw 9. The assembling order of these members can be variously changed, and the electrical connection between the electronic circuit and the pressure sensor 5 in the case 2 is performed via a connection line (not illustrated).

In a state where the pressure sensor 5 is attached to the case 2 together with the housing 6, as illustrated in FIG. 6, the first annular protrusion portion 11a on the inner peripheral side of the packing 11 is compressed by being pressed against the outside surface portion 5b around the protrusion portion 5a of the pressure sensor 5. In addition, the second annular protrusion portion 11b on the outer peripheral side of the packing 11 is compressed by being pressed against the stepped recessed portion 6c of the housing 6. Accordingly, it is possible to seal the gap between the periphery of the pressure sensor 5 and the inner wall of the accommodation portion 6b and to block water and air from the outside.

As described above, in this embodiment, since the housing 6 accommodating the pressure sensor 5 is attached to the attachment surface portion 2d provided on the outside surface of the case 2, the sensor accommodation portion which is provided to the case 2 in order to attach the sensor is small in scale.

In addition, the foreign matter intrusion prevention cover 10 interposed between the sensor cover 8 and the housing 6 is provided, and the foreign matter intrusion prevention cover 10 includes a plurality of small holes 10a each of which has an area smaller than the opening area of the communication portion 8a provided to the sensor cover 8 and thus it prevents dust from intruding into the pressure sensor 5 and prevents direct contact of dust or the like to the pressure sensor 5 through the communication portion 8a of the sensor cover 8.

In addition, in this embodiment, the pressure sensor 5 is accommodated in the accommodation portion 6b having the sensor support portion 6d supporting the inside of the pressure sensor 5, and the packing 11 provided outside the pressure sensor 5 has a two mountain structure including a first annular protrusion portion 11a which is in contact with the outside surface of the pressure sensor 5 and a second annular protrusion portion 11b which is positioned on the outer peripheral side of the first annular protrusion portion 11a and is in contact with a surface of the housing 6 around the sensor. Therefore, these annular protrusion portions 11a and 11b individually contact the outside surface portion 5b of the pressure sensor 5 and the stepped recessed portion 6c, respectively, and even if there is a positional deviation between the annular protrusion portions 11a and 11b and the outside surface portion 5b of the pressure sensor 5 and the stepped recessed portion 6c, respectively, the annular protrusion portions 11a and 11b are compressed corresponding to the positional deviation, and excellent air and water tightness is obtained.

In addition, the first annular protrusion portion 11a on the inner peripheral side is in contact with the outside surface portion 5b of the pressure sensor 5, thereby a function of positioning so as to regulate the position in the inner and outer direction of the sensor is exhibited. In addition, in this embodiment, since there is provided a structure in which the protrusion portion 5a of the pressure sensor 5 is fitted by the first annular protrusion portion 11a, the first annular protrusion portion 11a also functions to position the pressure sensor 5 in the radial direction.

In addition, in this embodiment, since the stepped recessed portion 6c for accommodating the packing 11 is provided around the accommodation portion 6b of the pressure sensor 5 provided in the housing 6, the pressure sensor 5 and the packing 11 are likely to be incorporated into the housing 6.

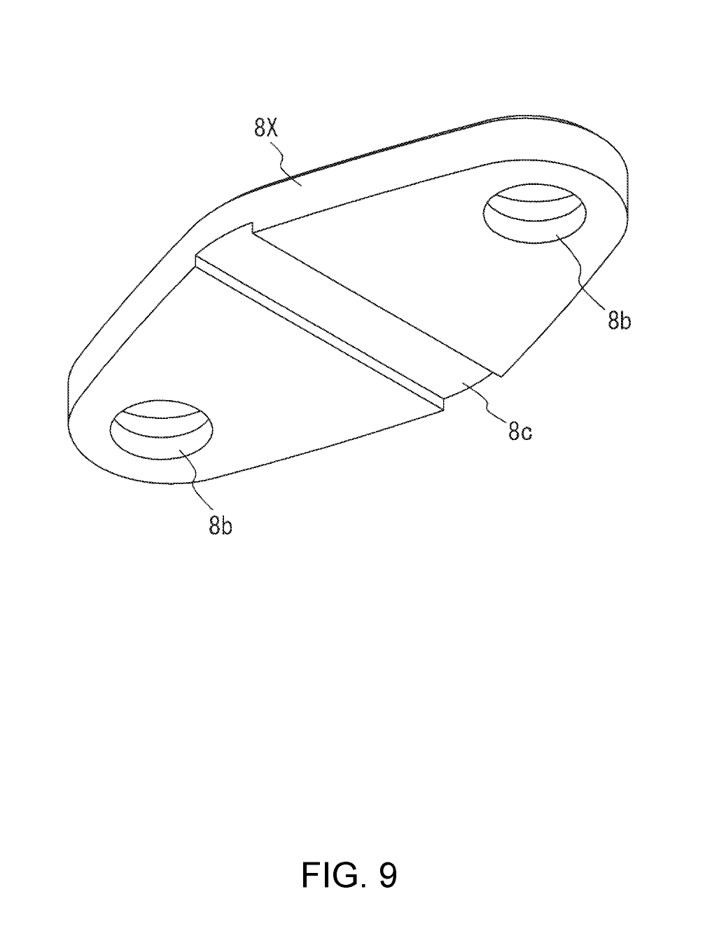

FIG. 9 illustrates another example of the sensor cover, and the sensor cover 8X forms the communication portion 8c for communicating the pressure sensor 5 with the outside on the case 2 side, that is, a surface of the pressure sensor 5 side as a groove shape.

In this way, in the example of FIG. 9, since the communication portion 8c provided in the sensor cover 8X is formed as a groove provided on a surface of the inside which is the surface of the sensor cover 8X on the case 2 side, intrusion of foreign matter into the pressure sensor 5 is unlikely to be generated while the communication portion 8c of the sensor cover 8 is not exposed on the surface of the sensor cover 8X. The direction of the groove can be arbitrarily designed. For example, in the drawings, although it is provided along the short side direction of the sensor cover 8X, grooves may be formed so as to connect both of the through-holes 8b.

In this embodiment, as illustrated in FIG. 1, the pressure sensor 5 is provided at the 4 o'clock position of the wristwatch 1. The 4 o'clock position is a position where operation such as pushing is difficult in a case where the operation element 3 is provided. Accordingly, by providing the pressure sensor 5 which is not required to be operated at the 4 o'clock position of the wristwatch 1, it is possible to provide the operation element 3 requiring operation at 2 o'clock, 8 o'clock, 10 o'clock position, or the like and thus a reasonable disposition is realized. In addition, the pressure sensor 5 is unlikely to be hit the surface of the wrist.

In the embodiment described above, although the case 2 and the pressure sensor 5 are formed in a circular shape, the case 2 and the pressure sensor 5 may be formed in a polygonal shape such as a quadrangular shape or the like.

In addition, the invention is not constituted as a wristwatch and may be configured by being combined with a device dedicated to a depth meter or an altimeter, or a mechanism having other functions than the timepiece. In addition, the sensor attached to the case 2 may be other than a pressure sensor.

In addition, the invention is applicable not only to a wristwatch, but also to an information device for displaying information to a user and an information device for transmitting and receiving information to/from other devices. In particular, if the invention is applied to a wearable device, since it is preferable that the wearable device is small in view of attachment to the body, it exhibits an important effect of suppressing an increase in the size of the case when the sensor is provided.

Besides, in a case of implementing the invention, it is possible to make various changes and additions to constituent members and combinations thereof without departing from the gist of the invention.

What is claimed is:

1. A sensor attachment structure which attaches a pressure sensor to a case of a wristwatch, the structure comprising:
a housing that is attached to an outside surface of the case and includes an accommodation portion which accommodates the pressure sensor;
the pressure sensor that is accommodated in the accommodation portion; and
a sensor cover that includes a communication portion causing outside air to communicate with the pressure sensor and closes the accommodation portion.

2. The sensor attachment structure according to claim 1,
wherein a cover is provided between the sensor cover and the pressure sensor and the cover has a hole having an opening area smaller than an opening area of the communication portion.

3. The sensor attachment structure according to claim 1,
wherein the communication portion is a groove provided on a surface of the sensor cover on a side of the accommodation portion.

4. The sensor attachment structure according to claim 2,
wherein the communication portion is a groove provided on a surface of the sensor cover on a side of the accommodation portion.

5. The sensor attachment structure according to claim 1, further comprising:
a packing which seals a gap between the accommodation portion and the pressure sensor.

6. The sensor attachment structure according to claim 4, further comprising:
a packing which seals a gap between the accommodation portion and the pressure sensor.

7. The sensor attachment structure according to claim 5,
wherein the packing has a annular protrusion portion corresponding to the position of the gap between the pressure sensor and the accommodation portion.

8. The sensor attachment structure according to claim 6,
wherein the packing has a annular protrusion portion corresponding to the position of the gap between the pressure sensor and the accommodation portion.

9. The sensor attachment structure according to claim 4,
wherein the housing has a stepped recessed portion which is provided continuously on the accommodation portion and into which the packing is fitted.

10. The sensor attachment structure according to claim 8,
wherein the housing has a stepped recessed portion which is provided continuously on the accommodation portion and into which the packing is fitted.

11. A wristwatch in which an atmospheric pressure sensor is mounted from the outside of a case, comprising, at 4 o'clock position:
a sensor attachment structure including:
a housing that is attached to an outside surface of the case and includes an accommodation portion which accommodates the atmospheric pressure sensor,
a pressure sensor which is accommodated in the accommodation portion, and
a sensor cover which includes a communication portion causing the outside air to communicate with the pressure sensor and closes the accommodation portion.
